(19) United States
(12) Patent Application Publication
(10) Pub. No.: US 2016/0088970 A1
(43) Pub. Date: Mar. 31, 2016

(54) Inductively Heated Steam Cooking Apparatus

(71) Applicant: TF Cardinal, LLC, Fort Wayne, IN (US)

(72) Inventors: Benjamin Robert Tippmann, Fort Wayne, IN (US); Timothy Matthew Tippmann, Fort Wayne, IN (US); Bradley Wyatt Sordelet, Fort Wayne, IN (US); Brian Finley, Fort Wayne, IN (US)

(21) Appl. No.: 14/868,872

(22) Filed: Sep. 29, 2015

Related U.S. Application Data
(60) Provisional application No. 62/057,019, filed on Sep. 29, 2014.

(51) Int. Cl. A47J 27/04; H05B 6/12

(52) U.S. Cl. CPC A47J 27/04; H05B 6/12; A47J 2027/043; H05B 2206/02

(57) ABSTRACT

The invention relates to an apparatus for steam cooking and rethermalizing foods with increased efficiency, faster times, lesser water use, and lesser energy expenditure, comprising generally a cooking chamber comprising a housing substantially composed of a non-magnetic, non-ferrous material, a first reservoir portion within the cooking chamber for containing water to be steamed, a heating plate within said first reservoir portion, and an inductive heat source operable to create heat through induction within said heating plate located in proximity to the heating plate.

### CROSS-REFERENCES TO RELATED APPLICATIONS

This Application is a non-provisional of, and claims priority to, U.S. Patent Application No. 62/057,019, Inductively Heated Steam Cooking Apparatus, filed Sep. 29, 2014.

### STATEMENT REGARDING FEDERALLY SPONSORED RESEARCH OR DEVELOPMENT

Not applicable.

### BACKGROUND

The present invention refers to an apparatus used to steam cook, heat, reheat, or thermalize food products with relatively low power usage, water usage, corrosion, and wear, and improved repairability, compared to steam cooking apparatuses known to the art. Embodiments of the present invention, in conjunction with other novel features, take advantage of non-ferrous housing materials and heating methods using induction.

Steam cookers of various kinds are widely known to the art. Steam cookers known to the art typically include a metal frame or housing, a large water reservoir, typically external to the cooking chamber, and an electric resistance or gas heat source to heat the water within the reservoir and convert it to steam. The steam is used, for example, to cook food within the cooking chamber, including particularly steamed seafoods, or to rethermalize frozen foods, particularly soups.

In these common applications, steam cookers known to the art suffer a number of drawbacks. First, in order to produce steam for extended periods of time, steam cookers known to the art typically include large water reservoirs which require significant amounts of energy to heat to steaming. Further, large water reservoirs make steam cookers known to the art unsuitable for on-demand use, since heating large volumes of water to steaming with conventional heat sources is a time- and energy intensive process. Further, steam cookers known to the art experience significant corrosion to the housing, heat elements, or both, due to extended periods of exposure to steam and heated water. In commercial settings, this requires the frequent replacement of steam cookers known to the art, at significant cost to commercial food establishments.

Induction heating methods for cooking are also known to the art. A wide variety of induction cookers exist, and generally comprise an induction coil, an electromagnet, a power source, and a heating plate. In induction cookers known to the art, the heating plate is generally either the top portion of the housing, or, optionally, the bottom surface of the pot or pan in which the food is cooked. As would be recognized by one skilled in the art, induction heating involves utilizing an electromagnet in conjunction with the coil to induce eddy currents in the heating plate. The heating plate's electrical resistance to those induced currents generates heat, which can be used to cook. Thus, the heating plate is generally substantially composed of conductive, and preferably ferromagnetic, material selected to provide a desired level of resistance to the induced eddy currents.

### SUMMARY

It is a therefore object of embodiments of the present invention to provide an inductively heated apparatus for steaming food, and particularly for extended use in steaming food, with improved energy efficiency compared to steamers known to the art. It is further an object of embodiments of the present invention to provide an inductively heated apparatus for steaming food, and particularly for extended use in steaming food, using lesser volumes of water than apparatuses known to the art. It is a further object of embodiments of the present invention to provide an inductively heated apparatus for steaming food, and particularly for extended use in steaming food, with increased resistance to corrosion and with sufficient modularity to allow corroded parts to be easily and inexpensively replaced. It is a further object of embodiments of the present invention to provide an inductively heated apparatus for steaming food, and particularly for extended use in steaming food, capable of maintaining a vacuum in the cooking chamber during use, enabling steaming to occur at lower temperatures and with higher latent heat than devices known to the art. It is a further object of embodiments of the present invention to provide an inductively heated apparatus for steaming food, and particularly for extended use in steaming food, with an improved ability to quickly generate steam after being activated. It is a further object of embodiments of the present invention to provide an inductively heated apparatus for steaming food, and particularly for extended use in steaming food, capable of on-demand steaming, and, in some embodiments, of automatic or on-demand replenishment of water to be converted to steam.

Embodiments of the apparatus of the present invention generally comprise a corrosion-resistant cooking chamber, preferably composed substantially of plastic, a first reservoir internal to the cook chamber, and as replaceable heating plate within said reservoir comprising a material that will generate heat if used in conjunction with an induction heating element. Embodiments of the present invention may further comprise an induction heating element. Embodiments of the present invention may further comprise one or more sealable openings to the cooking chamber and a pump configured to create and maintain a vacuum within the cooking chamber when said sealable openings are sealed closed. Embodiments of the present invention may further comprise a system for on-demand replenishment of water in the reservoir, including, by way of example, a float system operatively coupled to a valve, with the valve operatively coupled to an external water source such as a secondary reservoir or a water line.

Additional features and advantages of the present invention will be more readily understood from the description the embodiments that are described below by way of non-limiting example, with reference to the accompanying drawings.

Those skilled in the art will recognize that many designs and embodiments of the present invention are possible, and that the invention is not limited to the specific embodiments discussed herein.

### BRIEF DESCRIPTION OF DRAWINGS OF A PREFERRED EMBODIMENT

FIG. 1 is a side view of one embodiment of the present invention;

FIG. 2 is as top-down view of one embodiment of the present invention;

FIG. 3 is a perspective view of one embodiment of the present invention.

### DETAILED DESCRIPTION

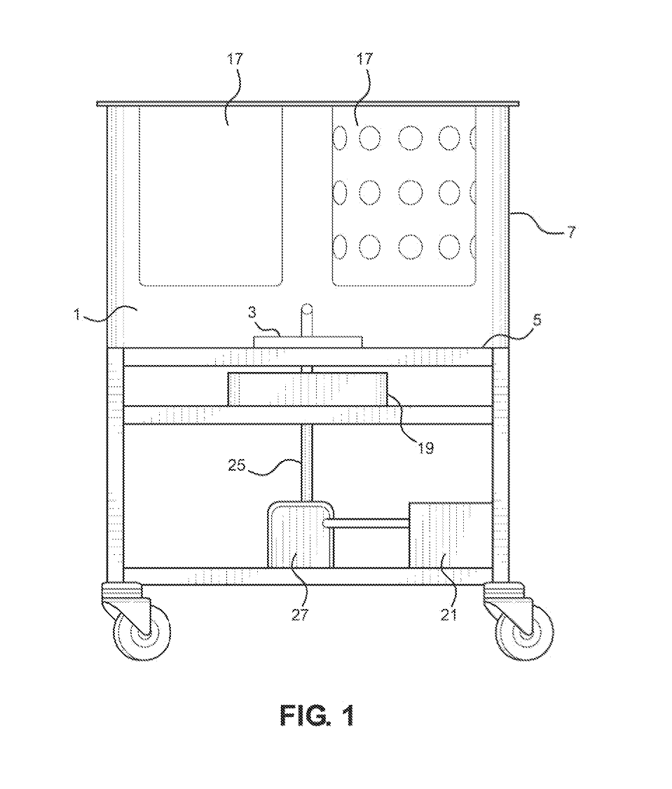

Embodiments of the present invention are directed to an inductively heated apparatus for use in steam cooking. As shown generally in FIG. 1, the inductively heated steam cooking apparatus comprises generally a cooking chamber (1) and a heating plate (3). The cooking chamber (1) comprises a housing with at least a floor (5) and walls (7). The cooking chamber (1) is composed substantially of non-magnetic, non-ferrous material that is food-safe and that will not substantially heat in response to induced eddy currents produced by an induction heating element (19). In preferred embodiments, the cooking chamber (1) is substantially composed of plastic.

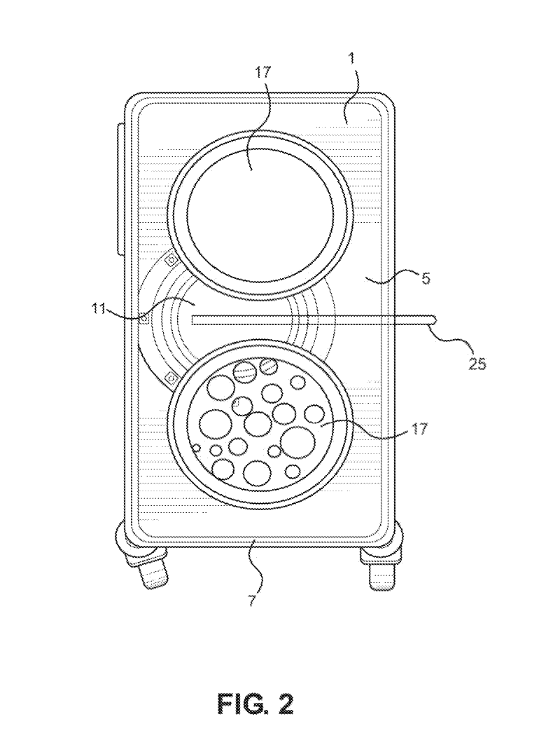

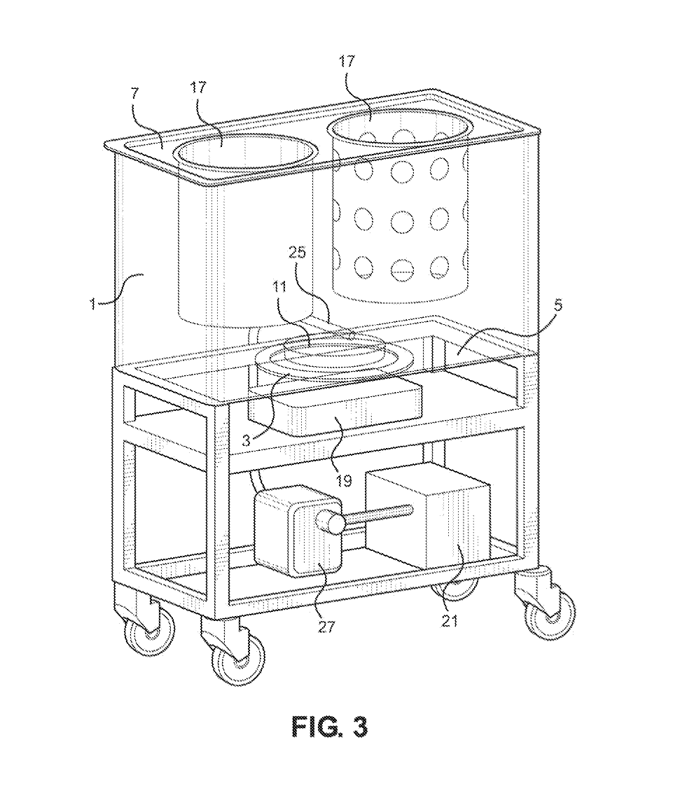

The interior of the cooking chamber (1) includes, and comprises, a first reservoir portion (11). The first reservoir portion (11) is configured to contain liquid, preferably water, winch may be selectively heated by the heating plate (3) to create steam. Virtually any volume of the interior space cit the cooking chamber (1) may be utilized as a first reservoir portion, so long as the food to be cooked is not submersed in the first reservoir portion (11) and the first reservoir portion (11) is configured to bring the liquid it contains into contact with, and, preferably, to submerse, the heating plate (3). Optionally, the first reservoir portion (11) may comprise the bottommost approximately ½ inch, approximately 1 inch, approximately 2 inches, approximately 3 inches, approximately 4 inches, approximately 5 inches, or approximately 6 inches of the interior of the cooking chamber (1). In a preferred embodiment, the first reservoir portion (11) comprises the lowermost portion of the interior space of the cooking chamber (1) up to and including a height of approximately ½ inch higher than the height defined by the thickness of the heating plate (3) when the heating plate (3) is laying within cooking chamber (1), as shown in FIG. 2. The first reservoir may optionally comprise a separate container within the cooking chamber (5). Still further optionally, only a portion of the cooking chamber floor (5) may optionally comprise a first reservoir (11) with first reservoir walls (9) defining the shape and height of the first reservoir portion (11), as shown in FIG. 3.

A number of advantages inhere in having a first reservoir portion (11) with a depth only slightly exceeding the thickness of the heating plate (3). Water at such a depth can be heated to steam relatively quickly and with a reduced expenditure of energy compared to steamers known to the art, which require large-volume reservoirs to be heated before steam is produced. Further, through induction heating, water within the first reservoir portion (11) may be kept at a temperature just below boiling at a relatively low energy cost, and, when steam is desired, such water can be converted to steam quickly through a slight increase in the temperature of the heating plate (3). Particularly when employed in conjunction with an optional second reservoir (21) and regulating means (25), steam can in this way be generated on-demand without substantial wait times and at a low relative energy cost compared to steamers known to the art.

The cooking chamber (1) preferably comprises a cooking chamber top (13). The cooking, chamber to (13) may comprise, for example, a hinged lid or a lift-off lid, which may further comprise a gasket or other seal to seal the cooking chamber top (13) to the cooking chamber walls (7). In the preferred version embodiment, the cooking chamber top comprises one or more apertures (15) to receive one or more food retention chambers (17). A food retention chamber (17) may he any vessel suitable to hold food during steam cooking, and may either transmit heat from steam within the cooking chamber (1) to the interior of the food retention chamber (17) or allow steam to pass from the cooking chamber (1) into the interior of the food retention chamber (17). A food retention chamber (17) is preferably composed substantially of heat-conductive metal, such as aluminum, and may comprise a cylinder, basket, or other vessel as will be appreciated by one skilled in the art. Preferably the food retention chamber (17) is a cylinder, with or without holes, including a circumferential lip configured to allow the food retention chamber (17) to hang within the cooking chamber (1) through the aperture (15).

In a most preferred version hereof there is a gasket, o-ring, or other seal disposed between circumferential lip of the food retention chamber (17) and the edge of the aperture (15) to dispose a seal at the interface between the food retention chamber (17) and the aperture (15). In these embodiments, the apparatus may further include one or more lids or covers configured to substantially seal the interior of the cooking chamber (1) or the food retention chambers from the outside air. Such lids or covers may substantially seal the interior of the cooking chamber (1) at least in part by, for example, providing a seal over the opening of the food retention chamber (17) and may further optionally compress the circumferential lip of the food retention chamber (17) against the gasket, o-ring, or other seal at the interface between the food retention chamber (17) upper lip and the aperture (15). These lids or covers may be separate from the cooking chamber top (13), or the cooking chamber top (13) may comprise one or more such lids or covers.

The heating plate (3) may be a plate of virtually any shape composed at least on its bottom surface of as material selected fur desired induction properties when used in conjunction with an induction heating element (19). Suitable materials are magnetic, and preferably, ferromagnetic with relatively high permeability. Suitable materials include, by way of example, iron, cast iron, and black iron. Other suitable materials will be apparent to one skilled in the art. In the preferred embodiment, the heating plate is magnetic-grade stainless steel. The heating plate [3] may be composed of multiple layers of materials, wherein at least the bottommost layer is composed substantially of a material suitable for induction and one or more upper layers are composed substantially of materials suitable for transferring heat from the induction layer into the cooking chamber (1). Upper layers in these embodiments may, by way of example, be composed of iron, steel, aluminum, copper, or their alloys.

The heating plate (3), when used in conjunction with an induction heating element (19) provides heat through induction heating processes known to the art. The heating plate (3) preferably lays on a portion of the cooking chamber floor (5) located within the first reservoir portion (11). Optionally, first reservoir walls (7) or other protrusions extending from the cooking chamber floor (5) may define a holding area for said heating plate (3). The heating plate (3) is, in preferred embodiments herein, easily removable from said cooking chamber (1) for maintenance or replacement. For example, in the embodiments shown in the Figures herein, the heating plate (3) may be removed for repair or replacement by lifting the heating plate (3) out of the cooking chamber (1).

The heating plate (3) provides heat, as will be appreciated by one skilled in the art, through resistance to eddy currents induced in the heating plate (3) magnetically by an induction heating element (19). Virtually any induction heating element (19) suitable to induce resistance in the selected heating plate (3) may be used, as will be appreciated by one skilled in the art. The present apparatus may comprise an induction heating element (19) within or below the cooking chamber floor (5) disposed beneath the heating plate (3). Optionally, a separate induction heating element (19) may be used in conjunction with the present apparatus by placing such separate induction heating element (19) beneath the portion of said cooking chamber (1) where said heating plate (3) lays. A wide variety of commercially available induction heating element (19) may be used in conjunction with the apparatus to heat the heating plate (3).

Embodiments of the present invention may further comprise a second reservoir (21) external to the cooking chamber (1), fluidly connected to the cooking chamber (1) by a conduit (23), to selectively replenish liquid, preferably water, within the first reservoir portion (1). The second reservoir (21) may be a container or vessel, or may comprise an external supplemental water source other than a vessel, such as a building's primary water line or supply.

When the apparatus is in use, liquid in the first reservoir portion (11) is evaporated as steam is formed. As will be appreciated by one skilled in the art, the level of liquid in the first reservoir portion (11) will becomes lower over time, particularly as steam is generated. In embodiments with an optional second reservoir (21), the second reservoir may selectively or automatically replenish liquid in the first reservoir portion (1) as the level of liquid in the first reservoir portion (11) decreases.

In some embodiments, the second reservoir (21) may be selectively activated by a user to replenish liquid in the first reservoir portion (11). For example, in embodiments in which the second reservoir (21) is a vessel, the second reservoir (21) may be operatively connected to a pump such that a user can activate the pump to force liquid from the second reservoir (21) through the conduit (23) into the first reservoir portion (21) until a desired level in the first reservoir portion (11) is reached, and then deactivate the pump to cease the flow of liquid from the second reservoir (21). In embodiments in which the second reservoir (21) is an external supplemental water source such as a water line, the conduit (23) may be operatively connected to a valve such that a user may selectively open the valve to allow water to flow into the first reservoir portion (11) until a desired level in the first reservoir portion (11) is reached and then may close the valve to cease the flow of water into the first reservoir portion (11).

In other embodiments, apparatus may include a regulating means (25) operatively connected to one or more of the first reservoir portion (11), conduit, (23), and second reservoir portion (21) for automatically causing or allowing liquid to flow from the second reservoir (21) to the first reservoir portion (11) under selected conditions. For example, in a preferred embodiment, the regulating means (25) is a float system. As will be appreciated by one skilled in the art, such a float system includes a float on the surface of liquid within said first reservoir (11) operatively connected to a valve, with the valve operatively connected to the conduit (23), such that when the float descends below a first predetermined level the valve opens and allows water to flow from the second reservoir (21) into the first reservoir portion (11), and when the float ascends above a second predetermined level the valve closes and prohibits water from flowing from the second reservoir (21) into the first reservoir portion (11). The first predetermined level and second predetermined level may be the same levels, or may be different levels. In these embodiments, the float being below the first predetermined level will be referred to as the regulating means being in a “first condition” and the float being above the second predetermined level will be referred to as the regulating means being in a “second condition.” It will be apparent to one skilled in the art that a variety of regulating means that can be placed in first conditions prohibiting water flow and second conditions permitting water flow could be used to automatically replenish the first reservoir portion (11) from the second reservoir (21), and all are within the scope and spirit of the present invention.

The cooking chamber (1) is in preferred embodiments sealable to form a vacuum when the apparatus is in use. These preferred embodiments include an air pump (27) in operative connection with the interior of the cooking chamber (1) to pump air out of the cooking chamber (1) and to form a vacuum within the cooking chamber (1) when desired by the user, preferably when the apparatus is in use. In a most preferred embodiment, the apparatus includes a cooking chamber top (13) with apertures (15), and food is placed within one or more food retention chambers (17) that sealably fit into said apertures (15). For example, there may be a gasket, o-ring, or other seal disposed between circumferential lip of the food retention retention chamber (17) and the edge of the aperture (15). The food retention chamber (17) may be impermeable to air, such as in the case of, for example, a solid metal cylinder, or may permeable to air, such as in the case of, for example, a basket or soup rethermalization container. In embodiments with food retention chambers (17) permeable to air where a vacuum is desired, the apparatus may further include one or more lids or covers configured to substantially seal the cooking chamber (1) by, for example, providing a seal over the opening of at least the air-permeable food retention chamber (17) and further optionally improving the seal between the food retention chamber (17) lip and the cooking chamber top (13) by compressing the circumferential lip of the food retention chamber (17) against the gasket, o-ring, or other seal at the interface between the food retention chamber (17) upper lip and the aperture (15).

Herein, “vacuum” and “substantial vacuum” refer to imperfect vacuum states, including “rough,” “fine,” and “high” vacuums, within the cooking chamber. “Vacuum” and “substantial vacuum” refer more specifically to any pressure state within the cooking chamber (1) lower than ambient pressure, and most preferably refer to a pressure state of less than 380 mm Hg within the cooking chamber (1).

As will be appreciated by one skilled in the art, forming a vacuum within the cooking chamber (1) creates a number of advantages. At standard atmospheric pressure of 760 mm Hg, water transitions to steam at 100 degrees Celsius, and such steam has latent heat of approximately 2256.56 kiloJoules per kilogram. At pressure of 380 mm Hg, water transitions to steam at approximately 81 degrees Celsius, and the steam has a latent heat of approximately 2301.91 kiloJoules per kilogram. At pressure of 190 mm Hg, water transitions to steam at approximately 65 degrees Celsius, and the steam has a latent heat of approximately 2334.98 kiloJoules per kilogram. Thus, as pressure within the cooking chamber (1) decreases, steam is formed at lower temperatures and thus with lower energy use. Steam formed at lower pressures also has increased latent heat, requiring less steam to be generated for cooking, which also saves both energy and water. Finally, the provision of a vacuum improves retention of steam within the cooking chamber (1), which decreases depletion of liquid within the first reservoir portion during steam production, further saving energy and water.

Embodiments of the apparatus described herein may be used in a variety of ways to heat, reheat, cook, or rethermalize food products. For example, in some embodiments, food may be placed or suspended directly within the open cooking chamber (1) and water within the first reservoir portion (11) heated using the heating plate (3) to create steam to steam-cook the food. A similar process may be used to, for example, thaw frozen food items or to rethermalize soup, which is commercial settings is often stored in bags configured to be steam-heated.

In other embodiments, the cooking chamber (1) may be closed, and, preferably, sealably closed. An air pump (27) may be used to create a vacuum within the cooking chamber, enabling steam to be generated a lower temperatures and with higher latent heat. In these embodiments, food products may be placed or suspended within the cooking chamber (1), which is sealably closed. The air pump (27) is activated to form a vacuum and the heating plate (3) is used to heat water within the first reservoir (11) to create steam to steam-cook the food. A similar process may be used to, for example, thaw frozen food items or to rethermalize soup.

In other embodiments, the cooking chamber top (13) may comprise apertures (15) configured to hold food retention chambers (17). Food may be cooked, or thawed, or rethermalized within these food retention chambers (17) with the cooking chamber (1) in either an open state, or a closed sealed state, as described above. The steam may be generated at ambient pressure, or in a vacuum, also as described above. In these embodiments, food products may be placed within one or more food retention chambers (17). The heating plate (3) is used to heat water within the first reservoir portion (11) to create steam. The steam either heats the conductive surfaces of the food retention chamber (17), or penetrates into the interior of the food retention chamber (17) or both, to steam-cook the food. A similar process may be used to, for example, thaw frozen food items or to rethermalize soup.

Although the present invention has been described in considerable detail with reference to certain preferred versions thereof, other versions are possible. Therefore, the spirit and scope of the claims should not be limited to the description of the preferred versions described herein.

What is claimed is:

1. An apparatus for steam cooking, comprising:
(a) a cooking chamber comprising a housing, said housing substantially composed of a non-magnetic, non-ferrous material;
(b) a first reservoir portion within said cooking chamber; and
(c) a heating plate within said first reservoir portion.

2. The apparatus of claim 1, further comprising an induction heating element in operative connection with said heating plate.

3. The apparatus of claim 2, further comprising a second reservoir external to said cooking chamber, wherein said second reservoir is fluidly connected to said cooking chamber.

4. The apparatus of claim 3, wherein said second reservoir is at least one of a vessel and a supplemental water source.

5. The apparatus of claim 4, wherein said cooking chamber comprises a cooking chamber top and said cooking chamber is sealable.

6. The apparatus of claim 5, further composing an air pump in operative connection with said cooking chamber, wherein said air pump creates a vacuum within said cooking chamber when said cooking chamber is sealed and said air pump is activated.

7. The apparatus of claim 6, wherein said housing is substantially composed of plastic.

8. The apparatus of claim 7, wherein said heating plate is removable from said apparatus by opening said cooking chamber top and lifting said heating plate out of said apparatus.

9. The apparatus of claim 8, wherein said cooking chamber top comprises at least one aperture, and said apparatus further comprises at least one food retention chamber.

10. The apparatus of claim 9, wherein said food retention chamber comprises a container removably insertable into said cooking chamber, wherein said food retention chamber forms a sealing connection with the portion of said cooking chamber defining said aperture.

11. The apparatus of claim 10, wherein said food retention chamber comprises one or more holes in one or more of the walls and floor of said food retention chamber, and said apparatus further comprises a cover configured to seal the said cooking chamber.

12. An apparatus for steam cooking, comprising:
(a) a cooking chamber comprising a housing, said housing being substantially composed of as non-ferrous material;
(b) a first reservoir within said cooking chamber;
(c) a heating plate within said first reservoir portion;
(d) a second reservoir external to said cooking chamber and in fluid connection with said cooking chamber;
(e) a valve operatively connected to said fluid connection between said second reservoir and said cooking chamber; and
(f) a regulating means operatively connected to said valve, wherein said valve allows water to flow from said second reservoir to said first reservoir portion when said regulating means is in a first condition and prohibits water from following from said second reservoir source to said first reservoir portion when said regulating means is in a second condition.

13. The apparatus of claim 12, further comprising a heating element in operative connection with said heating plate.

14. The apparatus of claim 13, wherein said second reservoir is at least one of a vessel and is supplemental water source.

15. The apparatus of claim 14, wherein said regulating means is at least one of: a float system, a timer, and a user control.

16. The apparatus of claim 15, wherein said cooking chamber is sealable.

17. The apparatus of claim 16, further comprising an air pump in operative connection with said cooking chamber, wherein said air pump creates a vacuum within said cooking chamber when said cooking chamber is sealed and said air pump is activated.

18. The apparatus of claim 17, wherein said housing is substantially composed of plastic.

19. The apparatus of claim 18, further comprising at least one food retention chamber.

20. The apparatus of claim 19, wherein said food retention chamber comprises a container removably insertable into said cooking chamber, wherein said food retention chamber forms a sealing connection with the portion of said cooking chamber defining said aperture.
